(19) United States
(12) Patent Application Publication
(10) Pub. No.: US 2010/0244428 A1
(43) Pub. Date: Sep. 30, 2010

(54) SECURITY SHEET

(75) Inventor: Yuichi Hoshiyama, Tokyo (JP)

Correspondence Address: JORDAN AND HAMBURG LLP, 122 EAST 42ND STREET, SUITE 4000, NEW YORK, NY, 10168, US

(73) Assignee: SEMO Corporation, Chuo-ku, Tokyo (JP)

(21) Appl. No.: 12/743,959

(22) PCT Filed: Nov. 25, 2008
(86) PCT No.: PCT/JP2008/003466

§ 371 Date: May 20, 2010

(30) Foreign Application Priority Data
Nov. 22, 2007 (JP) 2007-303664
Nov. 29, 2007 (JP) 2007-309454
Nov. 29, 2007 (JP) 2007-309455
Dec. 6, 2007 (JP) 2007-316274

(51) Int. Cl. B42D 15/00

(52) U.S. Cl. 283/74; 283/94

(57) ABSTRACT

A security sheet having with high anti-forgery/falsification property has an engraving layer including a sheet surface provided with an engraved identification image and a visible image non-engraved and being identical in details to the identification image so as to allow observation by comparison. For example, when a policeman questions a suspicious person at night to ask that person to present an identification card, the policeman checks the engraved identification image through tactile sense and visual sense. At the same time, the policeman checks the engraved identification image and the non-engraved visible image identical in details thereto through observation by comparison between both images by visual sense and through face-to-face observation of the person. With this, identity of the person can be authenticated by making use of tactile sense and visual sense complementarily.

### BACKGROUND OF THE INVENTION

1. Field of the Invention

The present invention relates to security sheets, such as, for example, driver's licenses, employee ID cards, passports, or graduation certificates, for which prevention of forgery and falsification (hereinafter referred to as “forgery/falsification”) is socially requested and, in particular, to a security sheet having high anti-forgery/falsification property without any trouble in certifying personal identity.

2. Description of Related Art

There are security sheets typified by, for example, driver's licenses, employee ID cards, passports, or graduation certificates. Such a security sheet is provided with a name, address, and others of an individual and an identification image such as a personal portrait photograph. It is a strong social request to prevent a third party from abusing the security sheets. In view of such a social request, security sheets are required to have high anti-forgery/falsification function.

To meet this social request, for example, a first patent document discloses a watermark-engraved paper sheet formed of a support layer and an engraving layer. To the sheet, engraving is made from the engraving layer to the support layer. The degree of opacity of the support layer being equal to or lower than 70% is always lower than that of the engraving layer being equal to or higher than 40% to exhibit a difference in the degree of opacity between the support layer and the engraving layer being equal to or higher than 30%.

Also, the inventor suggests a security sheet for important documents. The security sheet has a support layer, a watermark engraving layer integrally formed on the support layer, a backside watermark mat layer integrally formed under the support layer, and a watermark print layer integrally formed under the watermark engraving layer and the backside watermark mat layer. The watermark engraving layer has one image printed in advance. The backside watermark mat layer has another different image printed in advance and a function resistant to electrification with surface roughness. The transmission density of the support layer is equal to or lower than 0.15. The transmission density of the support layer, the engraving layers, and backside mat layer is equal to or higher than 0.15 and equal to or lower than 1.00. The degree of surface gloss of engraving surfaces is equal to or lower than 10.0 (for example, refer to a second patent document).

According to studies by the inventor of the present invention, in general, security measures and activities taken by people who try to break them assumes a cat-and-mouse game at present. Therefore, there is no limit to security measures, and continuous development of improved or novel technology is always strongly requested.

First patent document: Japanese Unexamined Patent Application Publication No. 06-15794

Second patent document: Japanese Unexamined Patent Application Publication No. 2007-130855

### SUMMARY OF THE INVENTION

An object to be solved is to provide a security sheet having high anti-forgery/falsification property in view of the points that there is no limit to security measures and that continuous development of improved or novel technology is always strongly requested.

In order to obtain a security sheet having high anti-forgery/falsification property, a first aspect provides a security sheet having an engraving layer laid on a support layer, the engraving layer having a sheet surface on which an identification image for identifying an individual is engraved. The sheet surface is provided with a visible image formed by non-engraving and being identical in details to the identification image formed by engraving.

A second aspect provides a security sheet having an engraving layer laid on a support layer, the engraving layer having a sheet surface engraved with an identification image for identifying an individual. The sheet surface is provided with a watermark engraving area for watermark engraving and a raised engraving area for raised engraving. In the watermark engraving area, the identification image is watermark-engraved, and in the raised engraving area, the identification image is raised-engraved.

A third aspect provides a security sheet having a support layer interposed between a pair of engraving layers to which a common identification image for identifying an individual is watermark-engraved. The common identification images are positioned so as to overlap each other in a layer direction.

A fourth aspect provides a security sheet having an engraving layer laid on a support layer, the engraving layer having a sheet surface on which an identification image for identifying an individual is engraved. The sheet surface is provided with a security mark having a property of becoming visible and obvious by ultraviolet irradiation, the security mark with a portion chipped off by an engraving of the identification image.

According to the first aspect, the security sheet has the engraving layer laid on the support layer, the engraving layer having the sheet surface on which the identification image for identifying an individual engraved. The sheet surface is provided with a visible image relating to non-engraving identical in details to the engraved identification image. With this, for example, when a policeman questions a suspicious person at night to ask that person to present an identification card, the policeman checks the engraved identification image through tactile sense and visual sense. At the same time, the policeman checks the engraved identification image and the non-engraved visible image identical in details to the engraved identification image through observation by comparison between both images by visual sense and through face-to-face observation of the person. With this, identity of the person can be authenticated by making use of tactile sense and visual sense. As this result, a security sheet can have high anti-forgery/falsification property without any trouble in certifying personal identity.

According to the second aspect, the security sheet has the engraving layer laid on the support layer, the engraving layer having the sheet surface on which the identification image for identifying an individual engraved. The sheet surface is provided with a watermark engraving area for watermark engraving and a raised engraving area for raised engraving. In the watermark engraving area, the identification image is watermark-engraved, and in the raised engraving area, the identification image is raised-engraved. With this, for example, when a policeman questions a suspicious person at night to ask that person to present an identification card, the policeman can check the both identification images formed by watermark engraving and raised engraving through tactile sense and visual sense. For example, the identification image formed by watermark engraving and the identification image formed by raised engraving are images relating to an upper-body portrait of that person. Between the identification images formed by watermark engraving and raised engraving, there is a commonality that a background portion relating to the upper-body portrait is chipped off by engraving to raise the upper-body portrait in a convex shape with respect to the background portion, thereby making the upper-body portrait visible and obvious. These identification images are different in that, while the upper-body portrait is made visible and obvious by transmission light in the watermark engraved identification image, the upper-body portrait is made visible and obvious by reflected light in the raised-engraved identification image. Therefore, with both of these identification images different in engraving type and mechanism to make the image visible and obvious, identity of the person can be authenticated by making full use of tactile sense and visual sense. As a result, a security sheet can have high anti-forgery/falsification property without any trouble in certifying personal identity.

According to the third aspect, the security sheet has the support layer interposed between paired engraving layers to which the common identification image for identifying an individual is watermark-engraved. The common identification images are positioned so as to overlap each other in the layer direction. With this, the common identification image watermark-engraved on each of the frontside and backside can be checked with tactile sense and visual sense from each sides. Also, when the identification image is viewed from one side, the outline of the image overlaps the outline of the identification image on the other side, thereby creating a stereoscopic vision. With such a view full of interest, the identification images engraved with high accuracy can be presented. As a result, a security sheet can have high anti-forgery/falsification property without any trouble in certifying personal identity.

According to the fourth aspect, the security sheet has the engraving layer laid on the support layer, the engraving layer having the sheet surface engraved with the identification image for identifying an individual. The sheet surface is provided with the security mark having a property of becoming visible and obvious by ultraviolet irradiation, the security mark with the portion chipped off by an engraving of the identification image. With this, when the sheet surface is irradiated with ultraviolet rays in order to perform true-or-false determination on the security sheet, the security mark with the chipped-off portion exactly relevant to the engraved portion of the identification image becomes visible and obvious in a state that the continuity of the mark image is partially cut off. Therefore, by checking whether consistency between the identification image and the image missing portion in the security mark is ensured, true-or-false determination can be performed on the sheet. As a result, a security sheet can have high anti-forgery/falsification property without any trouble in certifying personal identity.

### BRIEF DESCRIPTION OF DRAWINGS

FIG. 1 is a schematic perspective view showing an outer appearance of an image engraving apparatus (common to first to fourth embodiments);

FIG. 2 is a perspective view showing main parts in the image engraving apparatus (common to the first to fourth embodiments);

FIG. 3 (A) is an enlarged descriptive diagram showing an engraving table incorporated in a reciprocating mechanism, and FIG. 3 (B) is a descriptive diagram showing a booklet-shaped medium to be engraved that is placed and fixed on the engraving table (common to the first to fourth embodiments);

FIG. 4 is an enlarged descriptive diagram showing the engraving table in a case that a sheet-like medium such as a graduation certificate or testimonial is adopted as a medium to be engraved (common to the first to fourth embodiments);

FIG. 5 is an enlarged descriptive diagram showing the engraving table in a case that a sheet-like medium such as a graduation certificate or testimonial is adopted as a medium to be engraved (common to the first to fourth embodiments);

FIG. 6 is a descriptive diagram of an example in which the security sheet according to the first and second embodiments is applied to an employee ID card as a medium to be engraved (common to the first and second embodiments);

FIG. 7 is an A-A sectional view showing main parts of the employee ID card (refer to FIG. 6) according to the first embodiment;

FIG. 8 is a B-B sectional view showing main parts of the employee ID card (refer to FIG. 6) according to the first embodiment;

FIG. 9 is a descriptive diagram of an example in which the security sheet according to the first and second embodiments is applied to a graduation certificate as a medium to be engraved (common to the first and second embodiments);

FIG. 10 is a descriptive diagram of an example in which the security sheet according to the first and second embodiments is applied to a personal authentication page of a passport as a medium to be engraved (common to the first and second embodiments);

FIG. 11 is an A-A sectional view showing main parts of an employee ID card (refer to FIG. 6) according to the second embodiment;

FIG. 12 is a B-B sectional view showing main parts of the employee ID card (refer to FIG. 6) according to the second embodiment;

FIG. 13 is an external view showing the frontside of an employee ID card in an example in which the security sheet according to the third embodiment is applied to the employee ID card as a medium to be engraved;

FIG. 14 is an external view showing the employee ID card (refer to FIG. 13) according to the third embodiment when viewed from the backside;

FIG. 15 is a C-C sectional view showing main parts of the employee ID card (refer to FIG. 13) according to the third embodiment;

FIG. 16 is a descriptive diagram of an example in which the security sheet according to the third embodiment is applied to a graduation certificate as a medium to be engraved;

FIG. 17 is a descriptive diagram of an example in which the security sheet according to the third embodiment is applied to a personal authentication page of a passport as a medium to be engraved;

FIG. 18 is a descriptive diagram of an example in which the security sheet according to the fourth embodiment is applied to a personal authentication page of a passport as a medium to be engraved;

FIG. 19 is a D-D sectional view showing main parts of the security sheet according to the fourth embodiment;

FIG. 20 is a state descriptive diagram in true-or-false determination in the security sheet according to the fourth embodiment;

FIG. 21 is a sectional view showing main parts of a modification example of the security sheet according to the fourth embodiment;

FIG. 22 is a descriptive diagram of an example in which the security sheet according to the fourth embodiment is applied to an employee ID card; and

FIG. 23 is a descriptive diagram of an example in which the security sheet according to the fourth embodiment is applied to a graduation certificate.

### DETAILED DESCRIPTION OF EMBODIMENTS

In order to provide a security sheet with high anti-forgery/falsification property without any trouble in certifying personal identity, it forms both of an engraved identification image and a non-engraved visible image identical in details to the identification image on a sheet surface of the engraving layer.

Security sheets according to a plurality of embodiment of the present invention is described in detail below with reference to the drawings. Prior to description of the security sheets according to the embodiments, an image engraving apparatus used for engraving on the security sheets will be described.

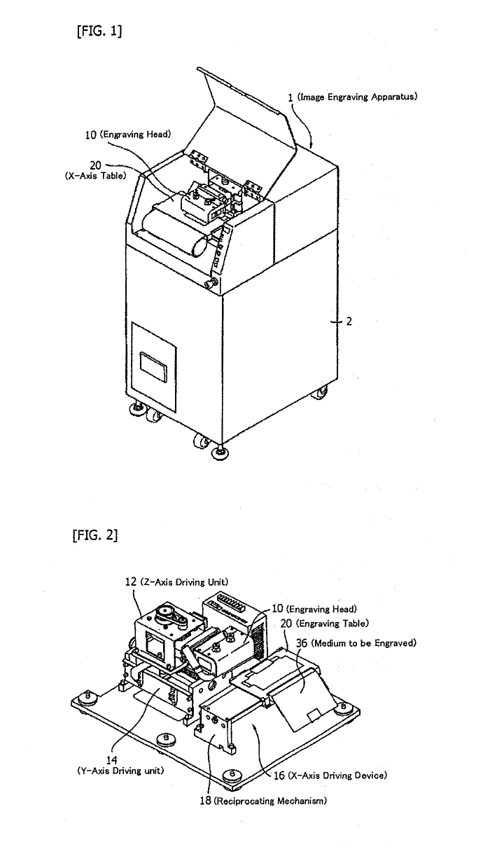

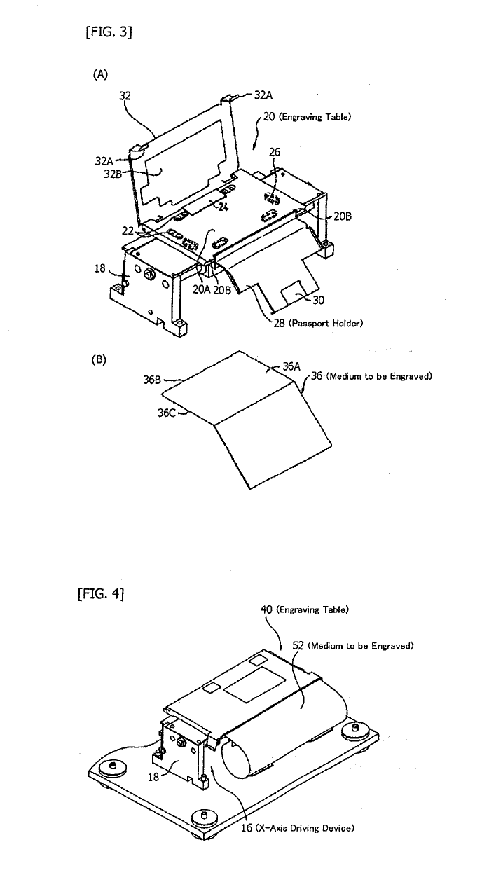

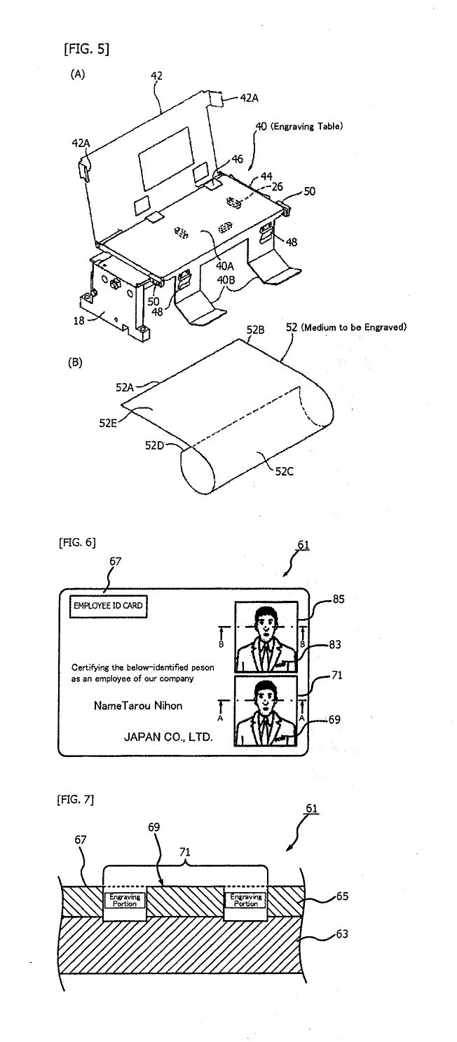

FIG. 1 is a schematic perspective view showing an outer appearance of the image engraving apparatus. FIG. 2 is a perspective view showing main parts in the image engraving apparatus. FIG. 3(A) is an enlarged descriptive diagram showing an engraving table incorporated in a reciprocating mechanism. FIG. 3(B) is an enlarged descriptive diagram of a booklet-shaped medium to be engraved that is placed and fixed on the engraving table. FIG. 4 and FIG. 5 are enlarged descriptive diagrams showing an engraving table when a relatively large sheet-like medium such as a graduation certificate or testimonial is adopted as a medium to be engraved.

As shown in FIG. 1, an image engraving apparatus 1 is used for engraving on the security sheet according to first to fourth embodiments. The apparatus 1 includes an apparatus body 2 incorporating a control device and others, an X-axis table (engraving table) 20 on which a medium to be engraved (corresponding to the security sheets according to the embodiments of the present invention) is placed and fixed to reciprocate the medium in an X-axis direction, and an engraving head 10 that is reciprocated by a Y-axis table (not shown) in a to-and-fro direction with respect to the X-axis table 20 and reciprocated by a Z-axis driving mechanism in a vertical direction and engraves the surface of the medium.

As shown in FIG. 2, the image engraving apparatus 1 vibrates the engraving head 10 on the basis of an input image signal. The engraving head 10 has an engraving needle for engraving an image on the medium.

The engraving head 10 is configured to be movable in a vertical direction by a driving mechanism including, for example, a stepping motor, timing belt, and ball screw incorporated in a Z-axis driving unit 12. Also, the engraving head 10 is configured to be movable in a to-and-fro direction by the Y-axis table driven by a Y-axis driving unit 14 disposed thereunder.

Ahead of the engraving head 10 an X-axis driving device 16 is disposed. The X-axis driving device 16 has a reciprocating mechanism (X-axis driving unit) 18 and the engraving table 20 that is provided on the mechanism 18 to reciprocate (move) in a lateral direction (X-axis direction). FIG. 2 shows the state in which a booklet-shaped passport is held and fixed as the medium 36 on the engraving table 20.

As shown in FIG. 3 (A), on the reciprocating mechanism 18, the engraving table 20 made of a non-magnetic material such as aluminum is provided. The engraving table 20 reciprocates in a horizontal (X-axis) direction according to the operation of the reciprocating mechanism 18.

On the top surface of this engraving table 20, medium guides 22 in the X-axis and Y-axis directions and a resilient first clip 24 are placed.

The engraving table 20 has fitting holes at four positions on the backside. A permanent magnet 26 is buried in each fitting hole. At the front end of this engraving table 20, a passport holder 28 is mounted with its tip end tilted downward. On the passport holder 28, a resilient second clip 30.

On a rear end side of the engraving table 20 opposite to the mounting position of the passport holder 28, a medium holder 32 is hinged and made of a resilient magnetic metal plate. At the tip ends on both sides of this medium holder 32, engaging portions 32A are provided to engage with engaged portions 20B provided at corresponding positions at the front end of the engraving table 20, thereby causing the medium holder 32 to be fixed. At the same time, the medium holder 32 is magnetically attracted by the permanent magnets 26 buried in the engraving table 20 so as to be brought into close contact with an engraving reference surface 20A on which the medium is placed.

In the above-configured engraving table 20, the medium holder 32 is first lifted upward to expose the engraving reference surface 20A of the engraving table 20 as shown in FIG. 3 (A). Next, a page 36A to be engraved of the booklet-shaped medium 36 shown in FIG. 3 (B) is brought into close contact with the engraving reference surface 20A, and a tip end 36B is pinched between the clip 24 and the engraving reference surface 20A.

At this time, the medium 36 is horizontally positioned by each of ends 36B and 36C pressed onto the medium guides 22 regulating the X direction and the Y direction. The remaining pages other than the page 36A are integrally folded and placed on the passport holder 28 to be held and pinched with the second clip 30 at rear ends thereof.

Next, the medium holder 32 is pressed onto the page 36A so that the page is held between the holder and the engraving reference surface 20A and the engaging portions 32A are resiliently engaged with the engaged portions 20B. At this time, the permanent magnets 26 magnetically attracts the medium holder 32 through the page 36A, and the page 36A is pressed in a flat state and strongly fixed in an close-contact state onto the reference surface 20A by the medium holder 32.

After fixing (holding) of the medium 36 is completed, the image engraving apparatus is driven to cut a portion of the page 36A exposed from an engraving window 22B of the medium holder 32 by the engraving needle for generating an engraved image.

At this time, the engraving table 20 on the reciprocating mechanism 18 makes a high-speed reciprocating movement with a cutting operation by the engraving needle to generate an engraved image on the page to be engraved 36A. Therefore, the page 36A tends to receive an action force to cause a positional shift due to an inertial force and a shift away from the engraving reference surface 20A due to cutting resistance.

However, with both of a pinching force by the first clip 24 and the second clip 30 and a magnetic attractive force of the permanent magnets 26 for the medium holder 32, the medium 36 resists the action force to be prevented from being positionally shifted from the reference surface 20A of the engraving table 20. Therefore, it can engrave an image sharply and accurately.

After image engraving, the medium 36 is released by resiliently disengaging the engaging portions 32A to free the medium holder 32, thereby being easily removed.

As described above, according to the engraving table 20 in the image engraving apparatus, when the booklet-shaped medium 36 is firmly fixed the magnetic attractive force and the engaging force between the holder 32 and the engraving table 20 instead of vacuuming. Therefore, it is not required to place a vacuum pump, vacuum circuit and others and microfabricate suction grooves or holes on the engraving reference surface, thereby simplifying the structure of the apparatus.

In a case that a relatively large sheet-like substance such as a graduation certificate or testimonial is adopted as a medium to be engraved, as shown in FIG. 4 and FIG. 5, the apparatus may employ a large engraving table 40 that allows such a large sheet-like engraving medium to be placed.

That is, the engraving table 40 is provided to the reciprocating mechanism 18 and is upsized so as to accommodate a relatively large medium such as a graduation certificate. In this case, the medium holder 42 is also upsized accordingly.

The engraving table 40 has ends on the upper surface that is provided with a medium guide 44 and resilient first clips 46. On the backside thereof, as described above, a plurality of fitting holes are formed such that permanent magnets 26 are buried in the fitting holes, respectively.

On the other hand, this engraving table 40 has a front end provided with medium holding portions 40B folded downward. On a hanging portion of each medium holding portion 40B, a resilient second clip 48 is mounted. On a rear end side of the engraving table 40 opposite to the mounting position of the medium holding portions 40B, a medium holder 42 similarly formed of a magnetic metal plate is hinged. Furthermore, on front ends on both sides of the engraving table 40 in a reciprocating direction, engaged pieces 50 are mounted. Engaging portions 42A at the tip end of the medium holder 42 engages with the engaged pieces 50 to fix the medium holder 42. At the same time, the permanent magnets 26 buried in the engraving table 40 magnetically attract the medium holder 42 so that the holder is brought into close contact with a reference surface 40A.

In the above-structured engraving table 40, the medium holder 42 is first lifted upward to expose the engraving reference surface 40A of the engraving table 40. Next, a tip end 52A of a sheet-like member 52 to be engraved shown in FIG. 5 (B) is pinched between the engraving reference surface 40A and the first clips 46.

At this time, positioning of the medium 52 is horizontally positioned by pressing so that the tip 52A bumps into the first clip 46 and also pushing a side end 52B onto the medium guide 44. The remaining portion of the medium 52 is folded back in a cylindrical shape to form a curled shape 52C and is placed so that its arc outer circumference is brought into contact with the medium holding portions 40B formed at a front end side of the engraving table 40. The curled tip end 52D is pinched by the second clips 44.

Next, the medium holder 42 is brought into close contact with the reference surface 40A from above the medium 52 and pressed so as to pinch the medium and resiliently engages the engaging portions 42A with the engaged pieces 50. At this time, the permanent magnets 26 magnetically attract the medium holder 42 through the medium 52 to firmly fix a portion 52E onto the reference surface 40A in a flatly close contact state.

By fixing the sheet-like medium to be engraved 52 in this manner, even when agitation occurs due to wind pressure caused by a high-speed reciprocating movement at the time of engraving, the curled shape 52C is formed to be in a cylindrical shape. Therefore, it can increase stiffness of the paper piece and reduce air resistance. Therefore, stable image engraving can be achieved.

According to the above-described engraving table 40, the sheet-like medium is curled in a cylindrical shape. Therefore, the reference surface of the engraving table is not required to be large enough to accommodate the entire medium, thereby allowing downsizing and light weight.

The medium is curled in a cylindrical shape, so that agitation occurring due to wind pressure caused by a high-speed reciprocating movement at the time of engraving can be prevented, thereby achieving stable image engraving.

Next, the security sheet according to the first embodiment in which an identification image for identifying individual is engraved by using the above-structured image engraving apparatus will be described in detail with reference to the drawings.

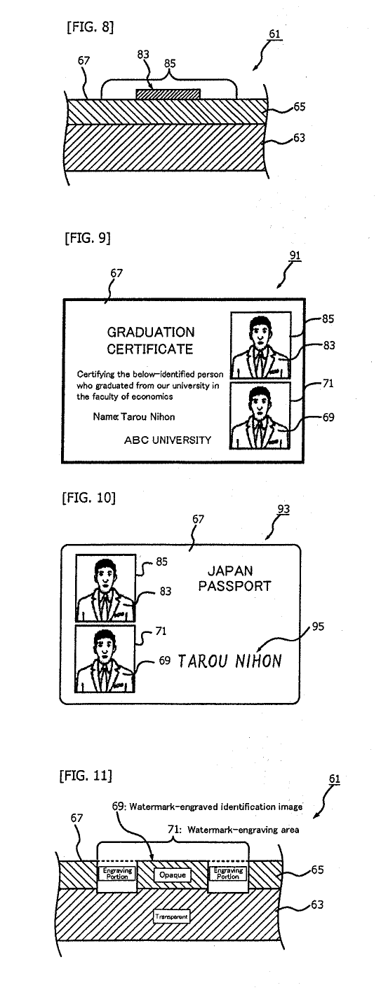

FIG. 6 is a descriptive diagram of an example in which the security sheet according to the first embodiment is applied to an employee ID card as a medium to be engraved. FIG. 7 is an A-A sectional view showing main parts of the employee ID card (refer to FIG. 6) according to the first embodiment. FIG. 8 is a B-B sectional view showing main parts of the employee ID card (refer to FIG. 6) according to the first embodiment. FIG. 9 is a descriptive diagram of an example in which the security sheet according to the first embodiment is applied to a graduation certificate. FIG. 10 is a descriptive diagram of an example in which the security sheet according to the first embodiment is applied to a personal authentication page of a passport.

In the security sheet according to the above-mentioned conventional technology, improvement of anti-forgery/falsification property is aimed through engraving an identification image such as a personal portrait. However, this identification image formed by engraving may cause inconvenience in certifying personal identity. For example, a policeman may question a suspicious person at night to ask that person to present an identification card on which a personal portrait as an identification image is watermark-engraved. In the low-light situation, it is hard to authenticate identity of the person through visual recognition of the watermark-engraved identification image.

For this, there is a strongly request for development of a novel technology without any trouble in certifying personal identity even when, for example, a policeman questions a suspicious person at night to ask that person to present an identification card.

To meet this request, the security sheet according to the first embodiment has an engraving layer laid on a support layer, the engraving layer having a sheet surface on which an identification image for identifying an individual is engraved. The sheet surface is provided with a security mark having a property of becoming visible and obvious by ultraviolet irradiation. The security mark has a portion chipped off by an engraving of the identification image.

In the security sheet according to the first embodiment, the security mark may be provided from outside of an engraving area in which the identification image is engraved on the sheet surface over the identification image.

In the security sheet according to the first embodiment, the security mark may be printed with ultraviolet luminescent ink on the sheet surface of the engraving layer.

In the security sheet according to the first embodiment, a plurality of security marks may be provided on the sheet surface.

In the security sheet according to the first embodiment, the security mark may be a seal or a symbol for authenticating the individual.

In the security sheet according to the first embodiment, the identification image may be one of or a combination of two or more of a name, address, age, sex, signature or imprint, and headshot of the individual.

In the security sheet according to the first embodiment, it may have a difference recognizable by naked eyes between a degree of opacity of the engraving layer and a degree of opacity of the support layer that is lower than the degree of opacity of the engraving layer. Additionally, watermark engraving may be made from the engraving layer to the support layer.

In the security sheet according to the first embodiment, it may have a difference recognizable by naked eyes between a density of color on the engraving layer and a density of color on the support layer that is higher than the density of color on the engraving layer. Additionally, raised engraving may be made from the engraving layer to the support layer.

As shown in FIG. 6 to FIG. 8, a security sheet (employee ID card) 61 according to the first embodiment has a support layer 63 and an engraving layer 65 that are laid on each other. The engraving layer 65 has a sheet surface 67 provided with an engraving area 71 in an approximately rectangular shape on which an identification image 69 for identifying an individual is engraved. In this engraving area 71, an upper-body portrait photograph image relating to the individual is engraved from an engraving layer 65 side as an identification image. The identification image in the present invention is an image having a function of identifying an individual. The identification image may include one of or a combination of two or more of a name, address, age, sex, signature (refer to a reference numeral “95” in FIG. 10) or imprint, and portrait photograph.

As the support layer 63, any material can be used as long as it is a generally-used transparent synthetic resin sheet (for example, polypropylene, polystyrene, polyethylene terephthalate, and vinyl chloride) and allows transparency to some degrees to be obtained. The thickness of the support layer 63 is preferably set to be approximately 0.1 to 0.3 mm. An appropriate thickness may vary according to the material, purpose, usage, versatility, and the like, so that these can be comprehensively taken into consideration to set its thickness as appropriate. Also, the property of hardness of the material greatly influences preservative quality of the engraved image. For this reason, bending properties and the like can be taken into consideration to set a suitable one as appropriate. As will be described further below, an identification image relating to a personal upper-body portrait photograph may be printed and processed on the sheet surface of the security sheet with an ink-jet printing, a dye-sublimation thermal transfer printing or the like. In this case, a hard transparent vinyl-chloride sheet or the like may be suitably used.

The engraving layer 65 can be made of a mixture formed by adding white ink (the filler is mainly titanium oxide and the like) and mat ink (the filler is mainly synthetic silica, calcium carbonate, barium sulfate, and any of kaolins, such as talc clay) into silk screen ink including resin (binder) and a filling material (filler), for example. The mixture is silk-screen-printed on the support layer 63. The property of the silk screen ink greatly varies depending on the supplier and type of that ink. In order to obtain appropriate transmission density and degree of gloss, the formula ratio is required to be reviewed as necessary. The thickness of the engraving layer 65 is 3 to 50 μm and, in particular, preferably 5 to 20 μm in the case of certificates. The type of resin (binder) used in the engraving layer 65 is preferably changed according to the resin used in the support layer 63, because different types of resin have different degrees of adhesiveness. For example, if the support layer 63 is a polyester film, a suitable type of resin (binder) used in the engraving layer 65 is polyester or polyurethane. Also, if the support layer 63 is made of hard vinyl chloride, a suitable type of resin (binder) used in the engraving layer 65 is polyurethane, vinyl chloride, vinyl acetate copolymer, or the like. The hardness of the engraving layer 65 can be adjusted by the type and the amount of hardening agent.

In the engraving area 71 on the security sheet according to the first embodiment, the identification image 69 is watermark-engraved. The security sheet preferably has a difference recognizable by naked eyes between the degree of opacity of the engraving layer 65 and the degree of opacity of the support layer 63 that is lower than the degree of opacity of the engraving layer 65. Additionally, engraving is preferably made from the engraving layer 65 to the support layer 63 (refer to FIG. 7). If these various conditions are satisfied, a watermark-engraved identification image recognizable by naked eyes can be obtained. Watermark engraving means that engraving is made from the engraving layer 65 to the support layer 63 to obtain the watermark-engraved identification image 69 recognizable by naked eyes in the security sheet with the degree of opacity of the support layer 63 lower than that of the engraving layer 65. In contrast, raised engraving means that engraving is made from the engraving layer 65 to the support layer 63 to obtain a raised-engraved identification image recognizable by naked eyes in the security sheet having a difference recognizable by naked eyes between the density of color on the engraving layer 65 and the density of color on the support layer 63 higher than that on the engraving layer 65. One of watermark engraving or raised engraving is performed depending on the structure on a security sheet side. According to the image engraving apparatus in the embodiment of the present invention, both watermark engraving and raised engraving can be performed.

On the frontside of the engraving layer 65 in the engraving area 71, a visible image 83 formed by full-color printing and being identical in details to the identification image 69 is provided at an adjacent position (including all positions adjacent to the identification image 69: above, below, left, and right) in a print area 85. The position allows observation by comparison with the identification image 69 relating to engraving. Identical details to the identification image 69 means the same size and scaling ratio. For example, in the case that the identification image 69 is a personal upper-body portrait photograph, the engraved identification image 69 (refer to FIG. 7) and the full-color printed visible image 83 (refer to FIG. 8) have approximately same size and scaling ratio and are adjacent to each other. This results in allowing observation by comparison between these images through visual sense. Observation by comparison means, as described in the embodiment of the present invention, observation by putting both images 69 and 83 as comparison targets in contrast with each other at the same time and place. In this manner, it can avoid overlooking a slightest inconsistency between minute portions in both images that tends to be inadvertently overlooked in separated comparison where both images are observed at different times and places. Therefore, for example, when a policeman questions a suspicious person at night to ask that person to present an identification card, the policeman can check the engraved identification image through tactile sense and visual sense. At the same time, the policeman can check the engraved identification image and the non-engraved visible image that are identical in details to each other through observation by comparison between both images by visual sense and through face-to-face observation of the person. With this, it can make identity confirmations by making use of tactile sense and visual sense complementarily. As this result, a security sheet can have high anti-forgery/falsification property without any trouble in certifying personal identity can be obtained.

In manufacturing the security sheet (employee ID card) 61 according to the first embodiment, on the sheet surface 67 configured by laminating the engraving layer 65 on the support layer 63, a base paper (employee ID card base paper) including the engraving area 71 and the print area 85 is prepared. Then, the identification image 69 relating to a personal upper-body portrait photograph is watermark-engraved in the engraving area 71 on the base paper (employee ID card base paper) with the image engraving apparatus 1 described above. The identification image 83 relating to the personal upper-body portrait photograph is full-color printed on the print area 85 on the base paper (employee ID card base paper) with an appropriate image forming apparatus (not shown) of an ink-jet printing, a dye-sublimation thermal transfer printing, or the like.

With this, for example, when a policeman questions a suspicious person at night to ask that person to present an identification card, the policeman can check the engraved identification image through tactile sense and visual sense. At the same time, the policeman can check the engraved identification image and the non-engraved visible image that are identical in details to each other through observation by comparison between both images by visual sense and through face-to-face observation of the person. With this, it can make identity confirmations by making use of tactile sense and visual sense complementarily. As a result, a security sheet can have high anti-forgery/falsification property without any trouble in certifying personal identity.

As the example of the security sheet (employee ID card) 61 according to the first embodiment, the identification image 83 full-color printed on the sheet surface 67 is exposed onto the frontside. The present invention is not restricted to this example. For example, a transparent coating layer may be provided on a surface of the identification image 83 to protect the full-color printed identification image 83 from flaws and exfoliation.

As the example of the security sheet 61 according to the first embodiment, an employee ID card is applied. The present invention is not restricted to this example. For example, as shown in FIG. 9, the present invention may be applied to a graduation certificate 91. The graduation certificate 91 shown in FIG. 9 has a basic structure common to the example of the employee ID card 61 described above, and common reference numerals are provided to parts common to both to omit redundant description. Furthermore, for example, as shown in FIG. 10, the present invention may be applied to a personal authentication page of a passport 93. The passport 93 shown in FIG. 10 has a basic structure common to the example of the employee ID card 61 described above, and common reference numerals are provided to members common to both to omit redundant description. With such a structure, the watermark-engraved identification image 69 and the full-color printed upper-body portrait photograph image 83 are combined to achieve a high anti-forgery/falsification function like the example of the employee ID card 61.

Furthermore, the invention according to the first embodiment may be applied to a credit card, for example. In this case, a magnetic tape or an IC chip may be added to the credit card to retain identification information regarding personal authentication such as a personal identification number.

As the example of the security sheet 61 according to the first embodiment, the employee ID card has the identification image 69 that is watermark-engraved (refer to FIG. 6 and FIG. 7). The watermark-engraved identification image 69 shown in FIG. 7 does not necessarily have a flat frontside. A necessary engraving process is performed according to identification image engraving data separately prepared for watermark engraving the identification image 69.

In the first embodiment, the identification image 69 is watermark-engraved in the engraving area 71 on the security sheet 61, for example. The present invention is not restricted to this example. The security sheet 61 may be configured as a security sheet having a difference recognizable by naked eyes between a density of color on the engraving layer 65 and a density of color on the support layer 63 that is higher than the density of color on the engraving layer 65. In the security sheet 61, engraving is made in the engraving area 71 from the engraving layer 65 to the support layer 63, thereby raised-engraving the identification image 69.

Next, the security sheet according to the second embodiment will be described in detail with reference to the drawings.

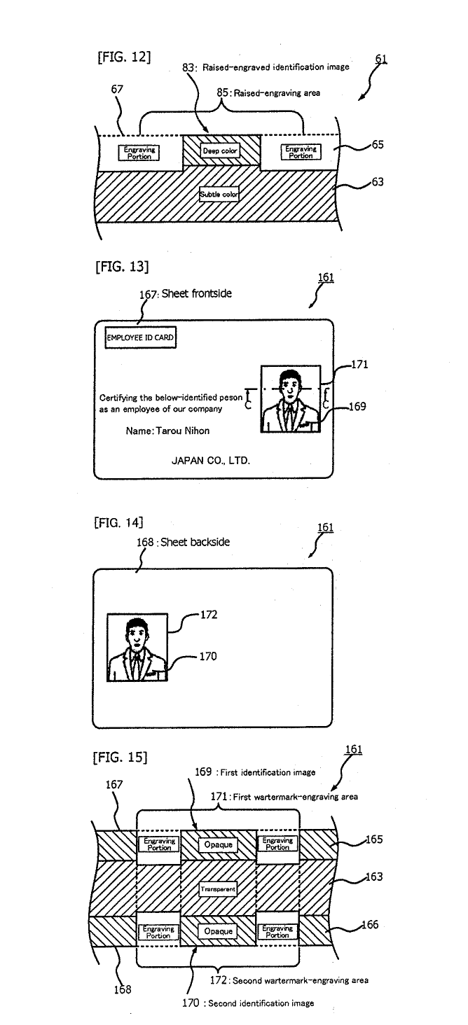

FIG. 11 is an A-A sectional view showing main parts of an employee ID card (refer to FIG. 6) according to the second embodiment. FIG. 12 is a B-B sectional view showing main parts of the employee ID card (refer to FIG. 6) according to the second embodiment. In the first and the second embodiments, there are parts having common functions. Therefore, common reference numerals are provided to parts common between the first and second embodiments to omit redundant description.

In the security sheet according to the above-mentioned conventional technology, anti-forgery/falsification is improved through engraving an identification image such as a personal portrait. However, this engraved identification image may cause inconvenience in certifying personal identity. For example, it is hard to authenticate identity of the person through visual recognition of a watermark-engraved identification image in low light when a policeman questions a suspicious person at night to ask that person to present an identification card with the watermark-engraved personal portrait.

For this, there is a strongly request for development of a novel technology without any trouble in certifying personal identity even when a policeman questions a suspicious person at night to ask that person to present an identification card, for example.

To meet this request, the security sheet according to the second embodiment has an engraving layer laid on a support layer, the engraving layer having a sheet surface on which an identification image is engraved for identifying an individual. The security sheet is provided with a watermark engraving area for watermark engraving and a raised engraving area for raised engraving on the sheet surface. The identification image is watermark-engraved in the watermark engraving area, and the identification image is raised-engraved in the raised engraving area.

In the security sheet according to the second embodiment, the identification image may be one of or a combination of two or more of a name, address, age, sex, signature, imprint, and portrait of the individual.

Furthermore, in the security sheet according to the second embodiment, the watermark engraving area and the raised engraving area may be provided adjacent to each other on the sheet surface.

Still further, in the security sheet according to the second embodiment, it may have a difference recognizable by naked eyes between a degree of opacity of the engraving layer and a degree of opacity of the support layer lower than that of the engraving layer. In this case, the identification image is watermark-engraved from the engraving layer to the support layer.

Still further, in the security sheet according to the second embodiment, it may have a difference recognizable by naked eyes between a density of color on the engraving layer and a density of color on the support layer that is higher than the density of color on the engraving layer. In this case, the identification image is raised-engraved from the engraving layer to the support layer.

Specifically, as shown in FIG. 6, FIG. 11, and FIG. 12, a security sheet (employee ID card) 61 according to the second embodiment is configured by laminating a support layer 63 and an engraving layer 65. The engraving layer 65 has a sheet surface 67 that is provided with a watermark engraving area 71 in an approximately rectangular shape on which an identification image 69 for identifying an individual is watermark-engraved. In this watermark engraving area 71, an upper-body portrait image relating to the individual is watermark-engraved from an engraving layer 65 side as an identification image.

On the other hand, on the frontside of the engraving layer 65 in the watermark engraving area 71, an identification image 83 is raised-engraved and is identical in details to the identification image 69 at an adjacent position (including all positions adjacent to the identification image 69: above, below, left, and right). The position allows the identification image 83 to be observed by comparison with the watermark-engraved identification image 69. Identical details to the identification image 69 is that the identification image 83 approximately has the same size and scaling ratio in the case of the identification image 69 being a personal upper-body portrait for example. In the second embodiment, the watermark-engraved identification image 69 (refer to FIG. 11) and the raised-engraved identification image 83 (refer to FIG. 12) are approximately identical in size and scaling ratio to each other and are adjacent to each other, thereby allowing observation by comparison between these engraved images through visual sense and tactile sense. The observation by comparison is, as described in the second embodiment, observation by putting both engraved images 69 and 83 as comparison targets in contrast with each other at the same time and place. In this manner, it can avoid overlooking a slightest inconsistency between minute portions in both images that tends to be inadvertently overlooked in separated comparison where both images are observed at different times and places.

In manufacturing the security sheet (employee ID card) 61 according to the second embodiment, on the sheet surface 67 configured by laminating the engraving layer 65 on the support layer 63, a base paper (employee ID card base paper) including the watermark engraving area 71 and a raised engraving area 85 is prepared. Then, the identification image 69 relating to a personal upper-body portrait is watermark-engraved by the image engraving apparatus 1 described above in the watermark engraving area 71 on the base paper (employee ID card base paper). At the same time, the identification image 83 relating to the personal upper-body portrait is watermark-engraved by the image engraving apparatus 1 described above in the watermark engraving area 85 on the base paper (employee ID card base paper).

With this, for example, when a policeman questions a suspicious person at night to ask that person to present an identification card, the policeman can check the identification images formed by watermark engraving and raised engraving through tactile sense and visual sense. The identification images relate to an upper-body portrait of a person. In both identification images, a background portion relating to the upper-body portrait is chipped off by engraving to raise the upper-body portrait in a convex shape with respect to the background portion, thereby making the upper-body portrait visible and obvious. However, these identification images are different in that the upper-body portrait is made visible and obvious by transmission light in the watermark-engraved identification image, whereas the upper-body portrait is made visible and obvious by reflected light in the raised-engraved identification image. Therefore, these identification images are different in engraving type and mechanism to make visible and obvious, so that they enables to make identity confirmations by making full use of tactile sense and visual sense. As this result, a security sheet can have high anti-forgery/falsification property without any trouble in certifying personal identity.

As the example of the security sheet according to the second embodiment, the employee ID card 61 is applied. The present invention is not restricted to this example. For example, as shown in FIG. 9, the present invention may be applied to a graduation certificate 91. The graduation certificate 91 shown in FIG. 9 has a basic structure common to the example of the employee ID card 61 described above, and common reference numerals are provided to parts common to both to omit redundant description. Furthermore, for example, as shown in FIG. 10, the present invention may be applied to a personal authentication page of a passport 93. The passport 93 shown in FIG. 10 has a basic structure common to the example of the employee ID card 61 described above, and common reference numerals are provided to members common to both to omit redundant description. With such a structure, the watermark-engraved identification image 69 and the raised-engraved identification image 83 are combined to achieve anti-forgery/falsification function like the example of the employee ID card 61.

The invention may also be applied to a credit card, for example. In this case, a magnetic tape or an IC chip may be added to the credit card to retain identification information regarding personal authentication such as a personal identification number.

Furthermore, as the example of the security sheet 61 according to the second embodiment, the employee ID card has the watermark-engraved identification image 69 and the raised-engraved identification image 83 (refer to FIG. 11 and FIG. 12). Each of the identification images 69 and 83 shown in FIG. 11 or FIG. 12 does not necessarily have a flat surface. A necessary engraving process is performed according to each piece of identification image engraving data separately prepared for engraving these identification images 69 and 83.

In the second embodiment, the watermark-engraved identification image 69 and the raised-engraved identification image 83 are images relating to a personal upper-body portrait. The present invention is not restricted to this example. Therefore, a security sheet according to the present invention may employ combining pieces of necessary identification information (for example, a name, address, age, sex, signature or imprint, and portrait). For example, a security sheet may adopt an upper-body portrait of an individual as the watermark-engraved identification image 69 and adopt a name and address of the individual as the raised-engraved identification image 83.

Next, the security sheet according to the third embodiment is described in detail with reference to the drawings.

FIG. 13 is an external view showing the frontside of an employee ID card in an example in which the security sheet according to the third embodiment is applied to the employee ID card as a medium to be engraved. FIG. 14 is an external view showing the employee ID card (refer to FIG. 13) according to the third embodiment when viewed from the backside. FIG. 15 is a C-C sectional view showing main parts of the employee ID card (refer to FIG. 13) according to the third embodiment. FIG. 16 is a descriptive diagram of an example in which the security sheet according to the third embodiment is applied to a graduation certificate as a medium to be engraved. FIG. 17 is a descriptive diagram of an example in which the security sheet according to the third embodiment is applied to a personal authentication page of a passport as a medium to be engraved.

The third embodiment can obtain a security sheet including an identification image engraved with high accuracy through a view full of interest to provide high anti-forgery/falsification property. The security sheet according to the third embodiment has a support layer interposed between paired engraving layers. On each of the paired engraving layers, a common identification image for identifying an individual is watermark-engraved. The common identification images are positioned so as to overlap each other in a layer direction.

In the security sheet according to the third embodiment, the identification image may be one of or a combination of two or more of a name, address, age, sex, signature, imprint, and portrait of the individual.

Furthermore, in the security sheet according to the third embodiment, it may have a difference recognizable by at least a visual check between a degree of opacity of the paired engraving layers and a degree of opacity of the support layer that is lower than the degree of opacity of the paired engraving layers. The common identification image is watermark-engraved from each of the paired engraving layers to the support layer. The watermark engraving area and the raised engraving area are adjacent to each other on the sheet surface.

In the security sheet according to the third embodiment, the paired engraving layers may have colors or degrees of opacities different from each other.

As shown in FIG. 13 to FIG. 15, a security sheet (employee ID card) 161 according to the third embodiment has a support layer 163 interposed between a pair of first and second engraving layers 165 and 166 so as to be brought into close contact therewith, thereby laminating these three layers.

On a frontside 167 of the security sheet 161, as shown in FIG. 13 and FIG. 15, a first watermark engraving area 171 in an approximately rectangular shape is provided. In the watermark engraving area 171, a personal upper-body portrait photograph image is engraved as a first identification image 169 for identifying an individual from a first engraving layer 165 side.

On a backside 168 of the security sheet 161, as shown in FIG. 14 and FIG. 15, a second watermark engraving area 172 in an approximately rectangular shape is provided. In the second watermark engraving area 172, a second identification image 172 is engraved and is common to the first identification image 169 from a second engraving layer 166 side. The second identification image 170 and the first identification image 169 overlap each other in a layer direction. Commonality between the first identification image 169 and the second identification image 170 means that, for example, in the case that the identification image 169 is a personal upper-body portrait photograph, these images are approximately identical in size and scaling ratio to each other.

The identification image in the present invention is an image having a function to identify an individual and including one of or a combination of two or more of a name, address, age, sex, signature (refer to a reference numeral “195” in FIG. 17) or imprint, and portrait photograph.

As the support layer 163, any material can be used as long as it is a generally-used transparent synthetic resin sheet (for example, polypropylene, polystyrene, polyethylene terephthalate, and vinyl chloride) and allows transparency to some degrees to be obtained. The thickness of the support layer 163 is preferably set to be approximately 0.1 to 0.3 mm. However, an appropriate thickness may vary according to the material, purpose, usage, versatility, and others, and these can be comprehensively taken into consideration to set its thickness as appropriate. The property of the material regarding hardness influences preservative quality of the engraved image. For this reason, properties of bending and the like can be taken into consideration to set a suitable one as appropriate. As will be described further below, an identification image relating to a personal upper-body portrait photograph may be printed and processed on the sheet surface of the security sheet with an ink-jet printing, a dye-sublimation thermal transfer printing, or the like. In this case, a hard transparent vinyl-chloride sheet or the like may be suitably used.

Each of the engraving layers 165 and 166 can be made of a mixture formed by adding white ink (the filler is mainly titanium oxide and the like) and mat ink (the filler is mainly synthetic silica, calcium carbonate, barium sulfate, and any of kaolins, such as talc clay) to silk screen ink including resin (binder) and a filling material (filler), for example. The mixture is silk-screen-printed on the support layer 163. The property of the silk screen ink greatly varies depending on the supplier and type of that ink. In order to obtain appropriate transmission density and degree of gloss, the formula ratio is required to be reviewed as necessary. The thickness of the each of the engraving layers 165 and 166 is 3 to 50 μm and, in particular, preferably 5 to 20 μm in the case of certificates. The type of resin (binder) used in each of the engraving layers 165 and 166 is preferably changed according to the resin used in the support layer 163, because different types of resin have different degrees of adhesiveness. For example, in the case that the support layer 163 is a polyester film, a suitable type of resin (binder) used in each of the engraving layers 165 and 166 is polyester or polyurethane. In the case of the support layer 163 made of hard vinyl chloride, a suitable type of resin (binder) in each of the engraving layers 165 and 166 is polyurethane, vinyl chloride, vinyl acetate copolymer, or the like. The hardness of each of the engraving layers 165 and 166 may be adjusted by the type and the amount of hardening agent.

The identification images 169 and 170 are watermark-engraved in the first and second watermark engraving areas 171 and 172 on the security sheet according to the third embodiment, respectively. The security sheet preferably has a difference recognizable by at least a visual check between the degree of opacity of each of the paired engraving layers 165 and 166 and the degree of opacity of the support layer 163 that is lower than the degree of opacity of each of the paired engraving layers 165 and 166. Additionally, engraving is preferably made from each of the pair of the engraving layers 165 and 166 to the support layer 163 (refer to FIG. 15). If these various conditions are satisfied, it can obtain a watermark-engraved identification image recognizable by naked eyes. In addition to the various conditions described above, it is preferable, in view of obtaining a clear watermark-engraved identification image, that the difference between the degree of opacity of the support layer 163 and the degree of opacity of each of the paired engraving layers 165 and 166 is larger. The watermark engraving means that, as described above, engraving is made from each of the paired engraving layers 165 and 166 to the support layer 163 to obtain the watermark-engraved identification images 169 and 170 recognizable by naked eyes in the security sheet configured so that the degree of opacity of the support layer 163 is lower than that of each of the paired engraving layers 165 and 166. In contrast, the raised engraving means that engraving is made from each of the engraving layers 165 and 166 to the support layer 163 to obtain a raised-engraved identification image recognizable by a visual check in the security sheet configured so that there is a difference with recognizable by at least a visual check between the density of color of each of the paired engraving layers 165 and 166 and the density of color of the support layer 163 that is higher than the density of color on each of the engraving layers 165 and 166. One of the watermark engraving or raised engraving is performed depending on the structure on a security sheet side. According to the image engraving apparatus in the embodiment of the present invention, both watermark engraving and raised engraving can be performed.

As a color each of the paired engraving layers 165 and 166, any color may be adopted, including not only an achromatic color such as white, black and gray, but also any of the other chromatic colors. In this regard, however, it is required to have the degree of opacity of each of the paired engraving layers 165 and 166 higher than that of the support layer 163. With this structure, it can obtain watermark-engraved identification images 169 and 170 with clear outlines. The paired engraving layers 165 and 166 may have a common color or different colors. As long as the degree of opacity of each of the paired engraving layers 165 and 166 is higher than that of the support layer 163, the paired engraving layers 165 and 166 have a common degree or different degrees of opacity.

In manufacturing the security sheet (employee ID card) 161 according to the third embodiment, the support layer 163 is interposed between the paired first and second engraving layers 165 and 166 to be brought into close contact therewith. In this way, these layers are laminated to form the security sheet 161. The security sheet 161 has the frontside 167 that is provided with the first watermark engraving area 171 and has the backside 168 that is provided with the second watermark engraving area 172, thereby preparing a base paper (employee ID card base paper). Then, in the first watermark engraving area 171 on the frontside 167 of the base paper (employee ID car base paper), the first identification image 169 relating to a personal upper-body portrait photograph is watermark-engraved by using the image engraving apparatus 1 described above from the first engraving layer 165 to the support layer 163. In the second watermark engraving area 172 on the backside 167 of the base paper, the second identification image 170 common to the first identification image 169 is watermark-engraved by using the image engraving apparatus 1 described above from the second engraving layer 166 to the support layer 163 so that the identification images overlap each other in the layer direction. When the second identification image 170 is watermark-engraved from the second engraving layer 166 to the support layer 163 so as to overlap the first identification image 169, it requires of positioning the first watermark engraving area 171 and the second watermark engraving area 172 to overlap each other in the layer direction and the second identification image 170 being mirror-reversed image of the first identification image 169 by engraving from the backside 168 side.

With this, the common identification images 169 and 170 watermark-engraved in the frontside 167 and the backside 168 can be checked with tactile sense and visual sense from the frontside 167 and the backside 168, respectively. When the identification image is viewed from one side, the outline of the image of the one side overlaps the outline of the identification image on the other side, thereby creating a stereoscopic vision. With such a view full of interest, the identification images engraved with high accuracy can be presented, and this results in obtaining a security sheet having high anti-forgery/falsification property without any trouble in certifying personal identity.

Furthermore, in the case that different colors are adopted for the respective engraving layers 165 and 166, the identification images 169 and 170 are visually recognized from the frontside and the backside with different colors from each other. Specifically, for example, a transparent one is adopted as a color for the support layer 163, pale pink is adopted as the color of the first engraving layer 65, and opaque white is adopted as a color for the second engraving layer 166. With such a view full of interest, the identification images engraved with high accuracy can be presented.

Furthermore, for example, a transparent one may be adopted as a color of the support layer 163, and red and green may be adopted as colors of the first and second engraving layers 165 and 166 from out of three primary colors of light, respectively. In this case, when the identification images 169 and 170 are viewed through from the frontside and the backside, they look yellow according to the additive process. Also, red and blue may be adopted as colors of the first and second engraving layers 165 and 166 from out of three primary colors of light. In this case, when the identification images 169 and 170 are viewed through from the frontside and the backside, they look magenta color according to the additive process. Still further, green and blue may be adopted as colors of the first and second engraving layers 165 and 166 from out of three primary colors of light. In this case, when the identification images 169 and 170 are viewed through from the frontside and the backside, they look cyan color according to the additive process. In this way, by adding a predetermined color to each of the identification images 169 and 170 according to the additive process, the identification images engraved with high accuracy can be presented with such a view full of interest.

As the security sheet 161 according to the third embodiment, the employee ID card is applied. The present invention is not restricted to this example. For example, as shown in FIG. 16, the present invention may be applied to a graduation certificate 191. The graduation certificate 191 shown in FIG. 16 has a basic structure common to the example of the employee ID card 161 described above, and common reference numerals are provided to members common to both to omit redundant description. Furthermore, as shown in FIG. 17, the present invention may be applied to a personal authentication page of a passport 193, for example. The passport 193 shown in FIG. 17 has a basic structure common to the example of the employee ID card 161 described above, and common reference numerals are provided to members common to both to omit redundant description. With such a structure, the first identification image 169 by the watermark engraving on the frontside and the second identification image 170 by the watermark engraving on the backside are combined to achieve a high anti-forgery/falsification function like the example of the employee ID card 161.

Furthermore, the present invention may be applied to a credit card, for example. In this case, a magnetic tape or an IC chip may be added to the credit card to retain identification information regarding personal authentication such as a personal identification number.

In the present invention, as the security sheet 161 according to the third embodiment, the employee ID card is applied and has the identification images 169 and 170 (refer to FIG. 13 to FIG. 15) watermark-engraved from frontside and backside thereof. Each of the watermark-engraved identification images 169 and 170 shown in FIG. 15 does not necessarily have a flat surface. A necessary engraving process with the position and depth regarding engraving are controlled according to identification image engraving data separately prepared for watermark-engraving the identification images 169 and 170.

Next, the security sheet according to the fourth embodiment is described in detail with reference to the drawings.

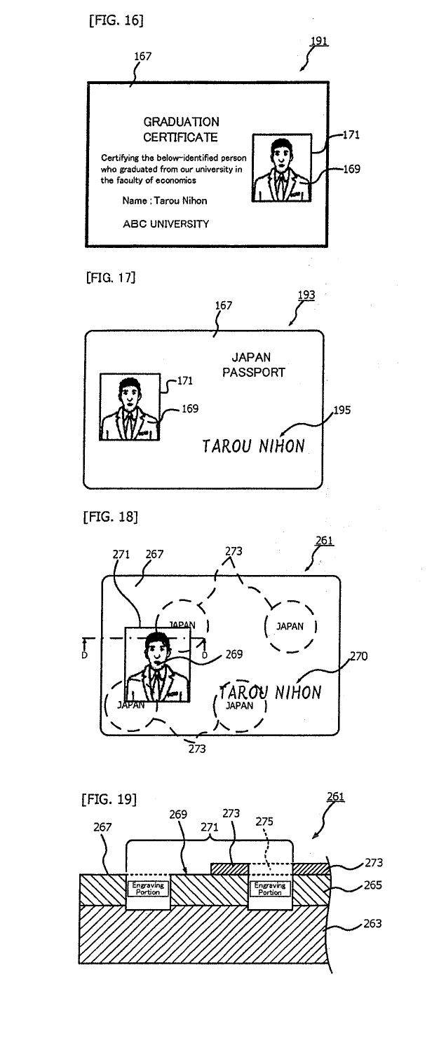

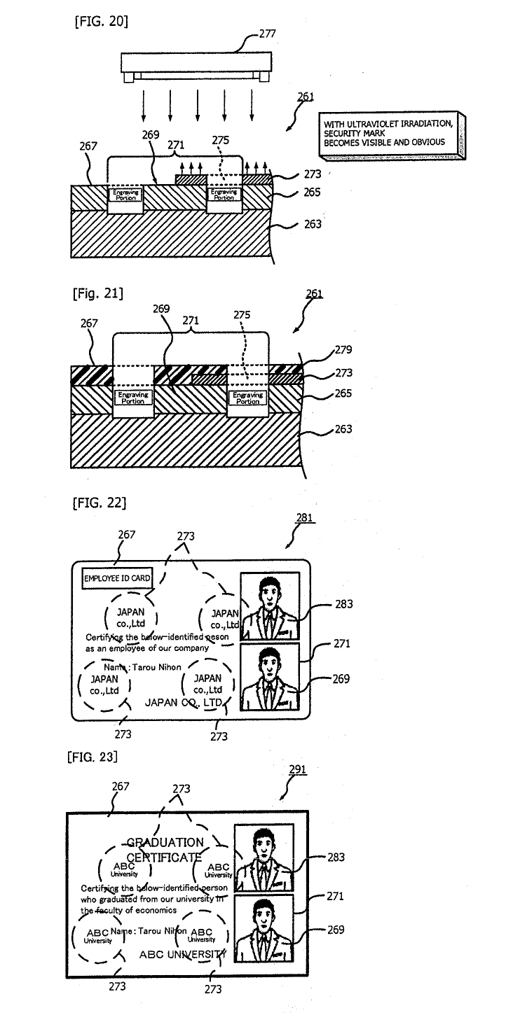

FIG. 18 is a descriptive diagram of an example in which the security sheet according to the fourth embodiment is applied to a personal authentication page of a passport as a medium to be engraved. FIG. 19 is a D-D sectional view showing main parts of the security sheet according to the fourth embodiment. FIG. 20 is a state descriptive diagram in true-or-false determination in the security sheet according to the fourth embodiment. FIG. 21 is a sectional view showing main parts of a modification example of the security sheet according to the fourth embodiment. FIG. 22 is a descriptive diagram of an example in which the security sheet according to the fourth embodiment is applied to an employee ID card. FIG. 23 is a descriptive diagram of an example in which the security sheet according to the fourth embodiment is applied to a graduation certificate.

In the security sheet according to the above-described conventional technology, it may employ a security mark such as counter-mark to improve anti-forgery/falsification property.

However, in a security sheet having an engraved identification image such as private information or a headshot, it is important to effectively provide a security mark to the security sheet in view of ensuring anti-forgery/falsification property.

From such a viewpoint, the security sheet according to the fourth embodiment has an engraving layer laid on a support layer, the engraving layer having a sheet surface on which an identification image is engraved for identifying an individual. The sheet surface is provided with a security mark becoming visible and obvious by ultraviolet irradiation according to a property thereof, and the security mark has a portion chipped off by an engraving of the identification image.

The security sheet according to the fourth embodiment may be provided with the security mark extending over the identification image from outside of an engraving area for the identification image on the sheet surface.

The security sheet according to the fourth embodiment may be provided with the security mark printed with ultraviolet luminescent ink on the sheet surface of the engraving layer.

The security sheet according to the fourth embodiment may have a plurality of the security marks provided on the sheet surface.

The security sheet according to the fourth embodiment may be provided with the security mark that is a seal or a symbol for authenticating the individual.

The security sheet according to the fourth embodiment may have one of or a combination of two or more of a name, address, age, sex, signature or imprint, and headshot of the individual as the identification image.

The security sheet according to the fourth embodiment may have a difference recognizable by naked eyes between a degree of opacity of the engraving layer and a degree of opacity of the support layer that is lower than the degree of opacity of the engraving layer. Additionally, the watermark engraving may be made from the engraving layer to the support layer.

The security sheet according to the fourth embodiment may have a difference recognizable by naked eyes between a density of color on the engraving layer and a density of color on the support layer that is higher than the density of color on the engraving layer. Additionally, the raised engraving may be made from the engraving layer to the support layer.

As shown in FIG. 18 and FIG. 19, a security sheet (personal authentication page of a passport) 261 according to the fourth embodiment has a support layer 263 and an engraving layer 265 that are laid on each other. The engraving layer 265 has a sheet surface 267 that is provided with an engraving area 271 having an approximately rectangular shape in which an identification image 269 for identifying an individual is engraved. In this engraving area 271, a personal headshot is engraved from an engraving layer 265 side as an identification image. The identification image in the present invention is an image having a function to identify an individual. The identification image may include one of or a combination of two or more of a name, address, age, sex, signature (refer to a reference numeral “270” in FIG. 18) or imprint, and portrait photograph.

As the support layer 263, any material can be used as long as it is a generally-used transparent synthetic resin sheet (for example, polypropylene, polystyrene, polyethylene terephthalate, and vinyl chloride) and allows transparency to some degrees to be obtained. The thickness of the support layer 263 is preferably set to be approximately 0.1 to 0.3 mm. However, an appropriate thickness may vary according to the material, purpose, usage, versatility, and the like, and these are comprehensively taken into consideration to set its thickness as appropriate. The property of hardness of the material greatly influences preservative quality of the engraved image. For this reason, bending property and the like required for the security sheet can be taken into consideration to set a suitable one as appropriate. A headshot image may be printed and processed on the sheet surface of the security sheet with an ink-jet printing, a dye-sublimation thermal transfer printing, or the like. In this case, a hard transparent vinyl-chloride sheet or the like may be suitably used.

The engraving layer 265 can be made of a mixture formed by adding white ink (the filler is mainly titanium oxide and the like) and mat ink (the filler is mainly synthetic silica, calcium carbonate, barium sulfate, and any of kaolins, such as talc clay) to silk screen ink including resin (binder) and a filling material (filler) for example. The mixture is silk-screen-printed on the support layer 263. The property of the silk screen ink greatly varies depending on the supplier and type of that ink. In order to obtain appropriate transmission density and degree of gloss, the formula ratio is required to be reviewed as necessary. The thickness of the engraving layer 265 is 3 to 50 μm and, in particular, preferably 5 to 20 μm in the case of certificates. The type of resin (binder) used in the engraving layer 265 is preferably changed according to the resin used in the support layer 263, because different types of resin have different degrees of adhesiveness. For example, if the support layer 263 is a polyester film, a suitable type of resin (binder) used in the engraving layer 265 is polyester or polyurethane. Also, if the support layer 263 is made of hard vinyl chloride, a suitable type of resin (binder) used in the engraving layer 265 is polyurethane, vinyl chloride, vinyl acetate copolymer, or the like. The hardness of the engraving layer 265 can be adjusted by the type of hardening agent and the amount of addition.

The engraving area 271 on the security sheet according to the fourth embodiment has the identification image 269 that is watermark-engraved. The security sheet preferably has a difference recognizable by naked eyes between the degree of opacity of the engraving layer 265 and the degree of opacity of the support layer 263 that is lower than the degree of opacity of the engraving layer 265. Engraving is preferably made from the engraving layer 265 to the support layer 263 (refer to FIG. 7). If these various conditions are satisfied, it can obtain a watermark-engraved identification image recognizable by naked eyes. The watermark engraving means that engraving is made from the engraving layer 265 to the support layer 263 to obtain the watermark-engraved identification image 269 recognizable by naked eyes in the security sheet in which the degree of opacity of the support layer 263 is lower than that of the engraving layer 265. In contrast, raised engraving means that engraving is made from the engraving layer 265 to the support layer 263 to obtain the raised-engraved identification image recognizable by naked eyes in the security sheet that has a difference recognizable by naked eyes between the density of color on the engraving layer 265 and the density of color on the support layer 263 that is higher than the density of color on the engraving layer 265. One of the watermark engraving or raised engraving is performed depending on the structure on a security sheet side. According to the image engraving apparatus in the embodiment of the present invention, both watermark engraving and raised engraving can be performed.

On the frontside of the engraving layer 265 in the engraving area 271, a security mark 273 is provided with a portion chipped off by the engraving of the identification image 269. The security mark in the present invention is the identification image 269 provided on the security sheet and keeping integration with the security sheet. In other words, the security mark is a mark that is put to verify that the identification image is not forged or falsified. In the example of FIG. 18, a plurality of security marks 273 (Optional number of security marks, for example, four security marks can be provided) are provided on the sheet surface 267. In the plurality of security marks 273 on the sheet surface 267, the size of each mark 273 and the spaces between the marks 273 are determined so as to position a part of at least one security mark 273 onto the identification image 269 in the engraving area 271.

The security mark 273 becomes visible and obvious by ultraviolet irradiation according to a property thereof. The security mark 273 is partly chipped off with the engraving of the identification image 269. The security mark 273 is formed by for example, a silk screen printing on the frontside of the engraving layer 265 on the sheet surface 267 with ultraviolet luminescent ink.

As the security mark 273, for example, it can employ a seal or symbol for identification according to a purpose of the security sheet. For example, if the security sheet is a passport, a seal or symbol of a nation (for example, Japan) corresponding to nationality of the individual can be used. Also, if the security sheet is an employee ID card, a seal or symbol of a company to which the employee belongs can be used. Furthermore, if the security sheet is a university graduation certificate, a seal or symbol of a university from which the individual graduated can be used.

The security mark 273 on the sheet surface 267, as shown in FIG. 18 and FIG. 19, is preferably provided so as to go across a space between the outside of the engraving area 271 and the identification image (for example, personal headshot) 269. With this structure, as will be described in detail further below, when the sheet surface 267 is irradiated with ultraviolet rays in order to perform true-or-false determination on the security sheet, the security mark 273 has the portion 275 that is chipped off and is exactly relevant to the engraved portion of the identification image 269 becomes visible and obvious in a state that the continuity of the mark image is partially cut off. Therefore, it can perform true-or-false determination on the sheet by checking consistency between the identification image 269 and the image missing portion in the security mark 273. As this result, a security sheet can have high anti-forgery/falsification property without any trouble in certifying personal identity.

In manufacturing the security sheet (passport) 261 according to the fourth embodiment, a base paper (passport base paper) with a plurality of (four) security marks 273 printed thereon is first prepared on the sheet surface 267 configured by laminating the engraving layer 265 on the support layer 263. Then, the identification image 269 relating to a personal headshot is watermark-engraved by the above-mentioned image engraving apparatus 1 in the engraving area 271 on this base paper (passport base paper). With this watermark engraving of the identification image 269, an engraved portion in each security mark 273 disposed so as to go across a space between the outside of the engraving area 271 and the identification image 269 is partially chipped off.

With this, as shown in FIG. 20, when the sheet surface 267 is irradiated with ultraviolet rays by an ultraviolet irradiation apparatus 277 in order to perform true-or-false determination on the security sheet, the security mark 273 with the chipped-off portion 275 exactly relevant to the engraved portion of the identification image 269 becomes visible and obvious in a state that the continuity of the mark image is partially cut off. Therefore, it can perform true-or-false determination on the sheet by checking consistency between the identification image 269 and the image missing portion 275 in the security mark 273. As this result, a security sheet can have high anti-forgery/falsification property without any trouble in certifying personal identity.

As the security sheet (passport) 261 according to the fourth embodiment, the security mark 273 is provided on the sheet surface 267 so as to be exposed on the frontside. The present invention is not restricted to this example. For example, as shown in FIG. 21, in order to protect the security mark 273 from flaws and exfoliation, a transparent coating layer 279 (having an ultraviolet transmission property) may be provided on the frontside of the security mark 273.

As the security sheet 261 according to the fourth embodiment, the passport is applied. The present invention is not restricted to this example. For example, as shown in FIG. 22, the present invention may be applied to an employee ID card 281. The employee ID card 281 depicted in FIG. 22 has a basic structure common to the example of the passport 261 described above, and common reference numerals are provided to members common to both to omit redundant description. Different points therebetween are now described. In this employee ID card 281, a headshot 283 of the relevant individual is full-color printed at a position adjacent to the identification image 269 on the sheet surface 267. With this structure, the watermark-engraved identification image 269 and the full-color printed headshot 283 are combined to further improve an anti-forgery/falsification function. Furthermore, for example, as shown in FIG. 23, the present invention may be applied to a graduation certificate 291. The graduation certificate 291 shown in FIG. 23 has a basic structure common to the example of the employee ID card 281 described above, and common reference numerals are provided to members common to both to omit redundant description. With this structure, the watermark-engraved identification image 269 and the full-color printed headshot 283 are combined to further improve an anti-forgery/falsification function like the example of the employee ID card 281.

In the fourth embodiment, the engraving area 271 in the security sheet 261 is watermark-engraved with the identification image 269. The present invention is not restricted to this example. The security sheet 261 may have a difference recognizable by naked eyes between a density of color on the engraving layer 265 and a density of color on the support layer 263 that is higher than the density of color on the engraving layer 265. Additionally, engraving may be made in the engraving area 271 from the engraving layer 265 to the support layer 263, thereby raised-engraving the identification image 269.

Finally, the present invention is not restricted to the embodiments described above, and may be modified as appropriate within a range of not being against the gist of the present invention read from the claims and the entire specification or technical thought. Such modified security sheets are also included in the technical range of the present invention.

The security sheet according to the present invention can be applied to general sheet-like documents such as, for example, driver's licenses, employee ID cards, passports, or graduation certificates, for which prevention of forgery/falsification is socially requested.

1. A security sheet having an engraving layer laid on a support layer, the engraving layer having a sheet surface on which an identification image for identifying an individual is engraved, the security sheet comprising:
a visible image formed on the sheet surface, the visible image non-engraved and being identical in details to the engraved identification image.

2. The security sheet according to claim 1, wherein
the non-engraved visible image identical in details to the engraved identification image is printed in color at a position on the sheet surface adjacent to an engraving area for the engraved identification image.

3. The security sheet according to claim 1, further comprising:
a difference recognizable by naked eyes exhibited between a degree of opacity of the engraving layer a degree of opacity of the support layer that is lower than the degree of opacity of the engraving layer; and
watermark engraving made from the engraving layer to the support layer.

4. The security sheet according to claim 1, further comprising:
a difference recognizable by naked eyes exhibited between a density of color on the engraving layer and a density of color on the support layer that is higher than the density of color on the engraving layer; and
raised engraving made from the engraving layer to the support layer.

5. A security sheet having an engraving layer laid on a support layer, the engraving layer having a sheet surface on which an identification image for identifying an individual is engraved, the security sheet comprising:
a watermark engraving area for watermark engraving and a raised engraving area for raised engraving that are provided on the sheet surface;
the watermark engraving area in which the identification image watermark-engraved; and
the raised engraving area in which the identification image is raised-engraved.

6. The security sheet according to claim 5, wherein
the watermark engraving area and the raised engraving area are provided at positions adjacent to each other on the sheet surface.

7. The security sheet according to claim 5, wherein
the watermark engraving area includes
a difference recognizable by naked eyes exhibited between a degree of opacity of the engraving layer and a degree of opacity of the support layer that is lower than the degree of opacity of the engraving layer, and
the identification image watermark-engraved from the engraving layer to the support layer.

8. The security sheet according to claim 5, wherein
the raised engraving area includes
a difference recognizable by naked eyes exhibited between a density of color on the engraving layer and a density of color on the support layer that is higher than the density of color on the engraving layer, and
the identification image is raised-engraved from the engraving layer to the support layer.

9. A security sheet having a support layer interposed between a pair of engraving layers, wherein
a common identification image for identifying an individual watermark-engraved in each engraving layer, the common identification images being positioned so as to overlap each other in a layer direction.

10. The security sheet according to claim 9, further comprising:
a difference recognizable by a visual check exhibited between a degree of opacity of the paired engraving layers and a degree of opacity of the support layer that is lower than the degree of opacity of the paired engraving layers; and
the common identification image watermark-engraved from each of the paired engraving layers to the support layer.

11. The security sheet according to claim 9, wherein
the paired engraving layers have colors or degrees of opacities different from each other.

12. A security sheet having an engraving layer laid on a support layer, the engraving layer having a sheet surface on which an identification image for identifying an individual is engraved, the security sheet comprising:
a security mark provided on the sheet surface and having a property of becoming visible and obvious by ultraviolet irradiation, the security mark with a portion chipped off by an engraving of the identification image.

13. The security sheet according to claim 12, wherein
the security mark is provided from outside of an engraving area of the identification image on the sheet surface over the identification image.

14. The security sheet according to claim 12, wherein
the security mark is printed with ultraviolet luminescent ink on the sheet surface of the engraving layer.

15. The security sheet according to claim 12, wherein
a plurality of the security marks are provided on the sheet surface.

16. The security sheet according to claim 12, wherein
the security mark is a seal or a symbol for authenticating the individual.

17. The security sheet according to claim 12, further comprising:
a difference recognizable by naked eyes exhibited between a degree of opacity of the engraving layer and a degree of opacity of the support layer that is lower than the degree of opacity of the engraving layer; and
watermark engraving made from the engraving layer to the support layer.

18. The security sheet according to claim 12, further comprising:
a difference recognizable by naked eyes exhibited between a density of color on the engraving layer and a density of color on the support layer that is higher than the density of color on the engraving layer; and
raised engraving made from the engraving layer to the support layer.

19. The security sheet according to claim 1, wherein
the identification image is one of or a combination of two or more of a name, address, age, sex, signature or imprint, and portrait photograph of the individual.
